(19) United States
(12) Patent Application Publication
(10) Pub. No.: US 2024/0301681 A1
(43) Pub. Date: Sep. 12, 2024

(54) TEMPERATURE SENSOR-BASED INSULATION FOR AGRICULTURAL BUILDING STRUCTURE

(71) Applicant: FROM THE LAND LLC, Yucaipa, CA (US)

(72) Inventors: Gina Carol Marie Oliver, Yucaipa, CA (US); Richard Stephen Hutchison, Yucaipa, CA (US)

(21) Appl. No.: 18/181,473

(22) Filed: Mar. 9, 2023

(51) Int. Cl. E04B 1/76; E04B 1/78

(52) U.S. Cl. CPC E04B 1/762; E04B 1/78

(57) ABSTRACT

A building structure automates control of insulation units. The insulation units deploy insulation components to cover portions of the building structure. For example, a first insulation unit deploys insulation on a first wall of the building structure, and a second insulation unit deploys insulation on a second wall of the building structure. A computing device processes data from sensors of the building structure to control the insulation units. For example, the insulation is deployed based on temperature readings or humidity readings inside or outside the building structure. The building structure can include other energy efficient components such as water tanks, geothermal ventilation, and a solar panel system.

### BACKGROUND

Conventional indoor agriculture facilities require a large footprint and have high energy costs, especially for heating and cooling systems. It is desirable to use energy-efficient solutions for indoor agriculture to reduce such energy costs.

### SUMMARY

In an embodiment, a building structure comprising a first wall comprising: a first plurality of sensors configured to output a first temperature reading of the first wall, and a first insulation unit configured to deploy a first insulation component on the first wall based on the first temperature reading. The building structure further comprises a second wall comprising: a second plurality of sensors configured to output a second temperature reading of the second wall, and a second insulation unit configured to deploy a second insulation component on the second wall based on the second temperature reading, independent of deployment of the first insulation component.

In some embodiments, the first insulation unit comprises a motor configured to deploy and retract the first insulation component on the first wall. In some embodiments, the first insulation component comprises a roll of flexible insulation material; the flexible insulation material is unrolled to cover a portion of the first wall when deployed. In some embodiments, the first insulation component comprises a rigid panel of insulation material; the rigid panel is rotated to cover a portion of the first wall when deployed. In some embodiments, the first insulation unit can be re-positioned to deploy the first insulation component on another part of the building structure.

In some embodiments, the first wall further comprises a humidity sensor; the first insulation unit is configured to deploy the first insulation component on the first wall based further on a humidity reading output by the humidity sensor.

In some embodiments, the building structure further comprises a plurality of water tanks including a first water tank configured to store cold water and a second water tank configured to store warm water. In some embodiments, the building structure further comprises one or more pumps configured to mix water in the plurality of water tanks; and a third plurality of sensors configured output temperature readings of the plurality of water tanks. In some embodiments, the building structure a solar panel system; the first insulation unit, the second insulation unit, and the one or more pumps are powered in part by the solar panel system.

In some embodiments, the first plurality of sensors includes a first array of sensors positioned on an interior of the building structure and a second array of sensors positioned on an exterior of the building.

In some embodiments, the building structure further comprises an automatic watering system for indoor agriculture.

In an embodiment, a method for providing insulation for a building structure comprises receiving, from a first plurality of sensors of a first wall of the building structure, a first temperature reading of the first wall. The method further comprises determining to deploy a first insulation component on the first wall based on the first temperature reading. The method further comprises receiving, from a second plurality of sensors of a second wall of the building structure, a second temperature reading of the second wall. The method further comprises determining to deploy a second insulation component on the second wall based on the second temperature reading, independent of deployment of the first insulation component.

In some embodiments, the method further comprises determining a predicted temperature reading of the first wall at a future point in time; determining to deploy the first insulation component on the first wall is based further on the predicted temperature reading.

In some embodiments, the method further comprises receiving a third temperature reading at a position of a water tank of the building structure. The method further comprises receiving a fourth temperature reading at a different position of the water tank. The method further comprises determining a difference between the third temperature reading and the fourth temperature reading. The method further comprises responsive to determining that the difference is greater than a threshold temperature value, operating a pump to mix water in the water tank.

In some embodiments, the method further comprises receiving a humidity reading from a humidity sensor inside the building structure. The method further comprises receiving an interior temperature reading of building structure. The method further comprises determining to retract the first insulation component on the first wall responsive to: determining that the humidity reading is greater than a threshold humidity value, and determining that the interior temperature reading is greater than a threshold temperature value.

### BRIEF DESCRIPTION OF DRAWINGS

FIG. 1 is an illustration of a building structure with insulation units according to an embodiment.

FIG. 2 is an illustration of a rear view of the building structure shown in FIG. 1 according to an embodiment.

FIG. 3 is an illustration of a top view of the building structure shown in FIG. 1 according to an embodiment.

FIG. 4 is an illustration of a side view of the building structure shown in FIG. 1 according to an embodiment.

FIG. 5 is an illustration of a side view of the building structure shown in FIG. 1 with insulation deployed according to an embodiment.

FIG. 6 is a flowchart of a process for providing insulation for a building structure according to an embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. Building Structure

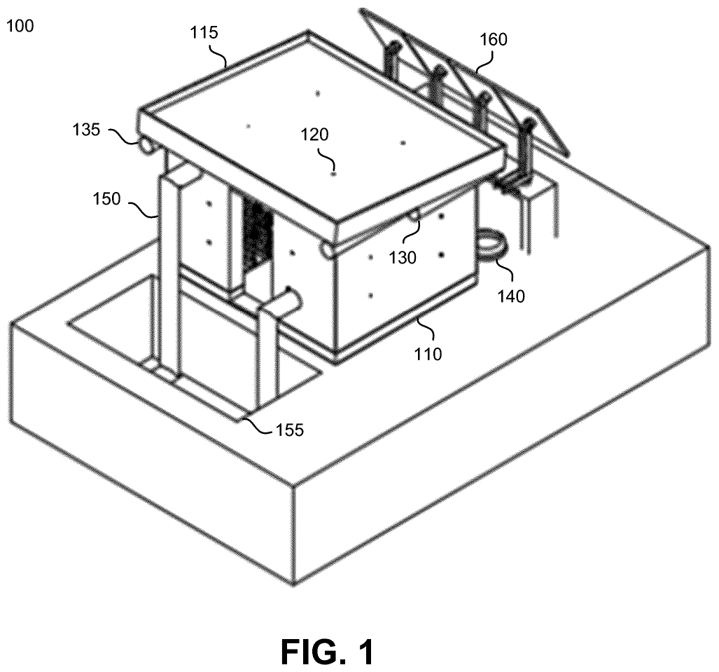

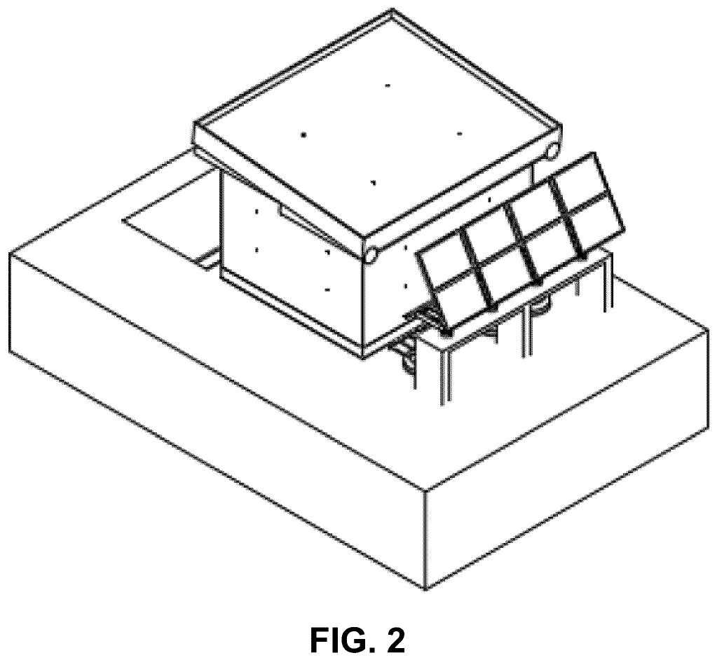

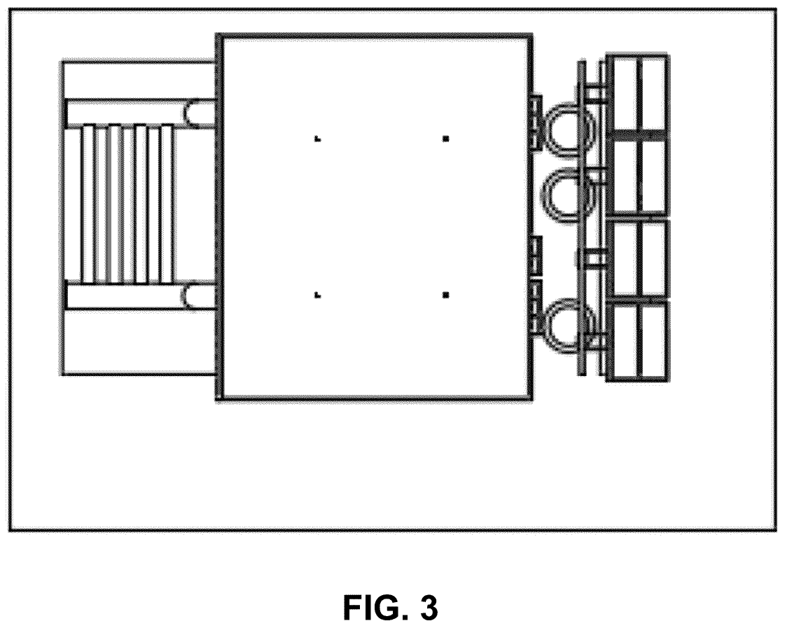

FIG. 1 is an illustration of a building structure 100 with insulation units according to an embodiment. FIG. 2 is an illustration of a rear view of the building structure 100 shown in FIG. 1 according to an embodiment. FIG. 3 is an illustration of a top view of the building structure 100 shown in FIG. 1 according to an embodiment.

The building structure 100 is used for indoor agriculture. For example, a user of the building structure 100 is a farmer who can grow produce (e.g., fruits and vegetables) and smaller types of livestock for protein (e.g., insects, mealworms, fishes, rabbits, chicken, quail, etc.). In some embodiments, the building structure 100 has an interior footprint of approximately 80 square feet and an exterior footprint of approximately 120 square feet; the footprint of the building structure 100 with additional components such as a geothermal vent 150, water tanks 140, and a solar panel system 160 (further described below) is approximately 216 square feet. The compact footprint enables the building structure 100 to be used not only in commercial farms with ample space but also settings with less available space such as a residential backyard. The compact footprint of the building structure 100 is suitable for vertical indoor farming. In some embodiments, the building structure 100 includes an automatic watering system for indoor agriculture. In some embodiments, the building structure 100 includes other components for indoor farming such as lighting and systems for active heating and cooling, among other components known to one skilled in the art.

In various embodiments, the building structure 100 comprises high thermal mass material. For example, walls and roof 115 of the building structure 100 are constructed using earthen materials such as cob/cobb, sand, clay, straw, rammed earth. The building structure 100 can also comprise other types of materials such as concrete, or any combination of earthen materials and other materials known to one skilled in the art. The use of these high thermal mass materials helps the building structure 100 absorb and retain heat. In an embodiment, the walls are approximately one foot thick, which increases the thermal mass property of the building structure 100. The thermal mass property of the building structure 100 provides a passive method of heating and cooling, which can be used in combination with one or more active systems or methods of heating and cooling as further described below.

### III. Insulation Units

The building structure 100 includes one or more insulation units. An insulation unit provides an insulation component that covers a portion of the building structure 100. The insulation component helps retain the heat absorbed by the thermal mass material of the building structure 100. An insulation unit can be adjustable such that a user can set up the insulation unit at a first position of the building structure 100 and then manually re-position the insulation unit to a second position of the building structure 100. It is advantageous to use adjustable insulation units because the areas of the building structure 100 that need insulation can change over time (e.g., over the course of a day, month, or year). For example, there is not a need for insulation during the day when there is sunlight because exposed walls of the building structure 100 can absorb heat from the sun. Once the sun has set, insulating the walls helps the building structure 100 retain the absorbed heat overnight. As sunlight and weather patterns change throughout a year, the optimal times to deploy insulation also changes. An active insulation system that automatically accounts for this variation helps to reduce the energy required to heat or cool the building structure 100.

In some embodiments, the insulation unit includes one or more motors to deploy and retract the insulation component. For example, the insulation component is a roll of flexible insulation material such as foam, fiberglass, mineral wool, natural fibers, or any combination thereof, including other types of materials with a high R-value. The motor deploys the roll of flexible insulation material such that the material is unrolled to cover a portion of the building structure 100. The motor retracts the roll of flexible insulation material to expose the portion when insulation is not needed for that portion. As a different example, the insulation component is in a form factor of blinds, shades, or shutters. The insulation unit includes a motor or another type of actuator such as a pneumatic cylinder or linear actuator to change the configuration of rigid panels of the blinds, shades, or shutters. For example, the rigid panels are rotated to change from an opened state to a closed state, or vice versa (covering or not covering a portion of the building structure 100).

In the embodiment shown in FIGS. 1-5, the building structure 100 includes a first insulation unit 130 coupled to a first wall of the building structure 100 and a second insulation unit 135 coupled to a second wall of the building structure 100. The first insulation unit 130 and second insulation unit 135 are positioned at the top of the walls such that the insulation component covers a portion of the walls when deployed. In some embodiments, the roof 115 includes an insulation unit. In other embodiments, the roof 115 is a green roof suitable for growing produce or other types of plants. A green roof can also include an insulation unit.

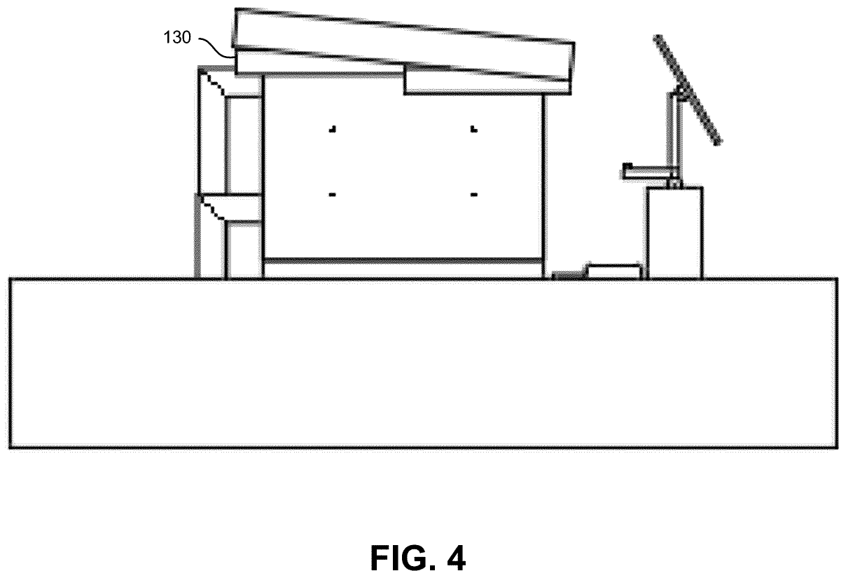

FIG. 4 is an illustration of a side view of the building structure 100 shown in FIG. 1 according to an embodiment. In this view, the insulation component of the first insulation unit 130 is retracted such that the wall is exposed.

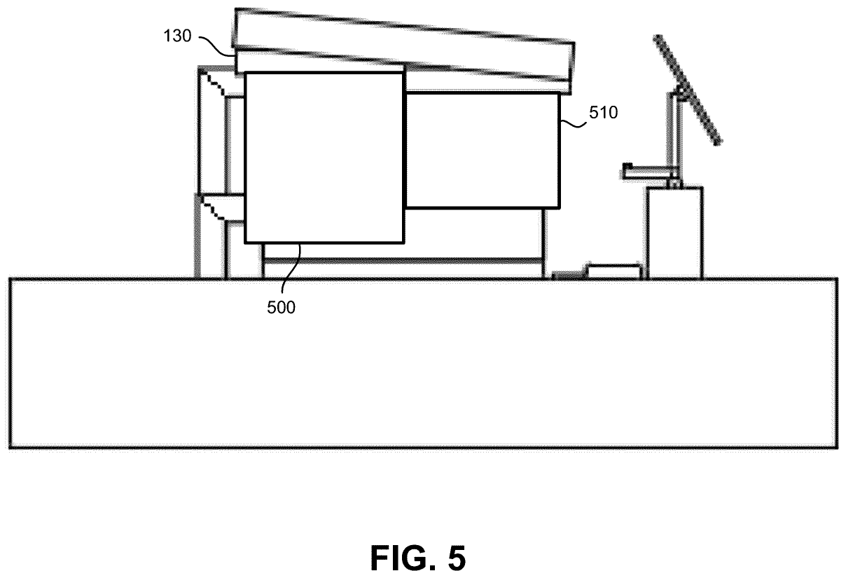

FIG. 5 is an illustration of a side view of the building structure 100 shown in FIG. 1 with insulation deployed according to an embodiment. In this view, the insulation component of the first insulation unit 130 is deployed such that a portion of the wall is covered and thus insulated by the insulation component. In the embodiment of FIG. 5, the insulation component is a roll of flexible insulation material including a first segment 500 and a second segment 510. The first insulation unit 130 can control the first segment 500 and the second segment 510 independently with each other. As shown in FIG. 5, the first segment 500 is deployed to cover a portion of the wall that is larger than the portion covered by the second segment 510. This functionality is advantageous because it enables more granular control of deploying insulation to specific portions of the building structure 100 that need insulation.

The first insulation unit 130 and the second insulation unit 135 can control deployment of insulation independently with each other. For example, the first insulation unit 130 is coupled to a wall facing the east-direction and the second insulation unit 135 is coupled to another wall facing the west-direction. In the morning, the wall facing the east-direction receives more sunlight, so the first insulation unit 130 retracts the insulation component and the second insulation unit 135 deploys the insulation component to cover the wall facing the west-direction that is not receiving as much sunlight. Then in the afternoon, the wall facing the west-direction receives more sunlight, so the first insulation unit 130 deploys the insulation component to cover the wall facing the east-direction that has absorbed heat during the morning and the second insulation unit 135 retracts the insulation component so that the wall facing the west-direction can absorb more heat.

In other embodiments, the building structure 100 includes insulation units in a different configuration than the example shown in FIGS. 1-5. For example, the building structure 100 includes insulation components having different form factors such as a roll of flexible insulation material to cover one wall and rigid insulation panels to cover a different wall. While FIG. 5 illustrates the insulation components being deployed in the vertical direction, the insulation components can be deployed in the horizontal direction in other embodiments.

In some embodiments, the building structure 100 includes a computing device (not shown in FIGS. 1-5) to operate the insulation units or other components of the building structure 100 (such as lighting, pumps, and an automatic watering system). The computing device includes one or more processors and memory storage to perform functionality such as automating control of the insulation units. For example, the computing device sends commands to the insulation units to deploy or retract insulation components at certain positions of the building structure 100.

The computing device receives and processes data from one or more sensors 120 such as temperature sensors and humidity sensors. In the embodiment shown in FIGS. 1-5, the building structure 100 includes sensors 120 coupled to each of the walls and the roof 115. The building structure 100 includes sensors 120 coupled to both the interior side and exterior side of the walls and roof 115, in order to measure the internal and external temperature of the building structure 100. In some embodiments, the sensors 120 are arranged as an array or grid on a wall, which enables the computing device to detect a temperature gradient on the wall. In other embodiments, sensors 120 are positioned on the ground or on other components of the building structure 100 or in the vicinity of the building structure 100.

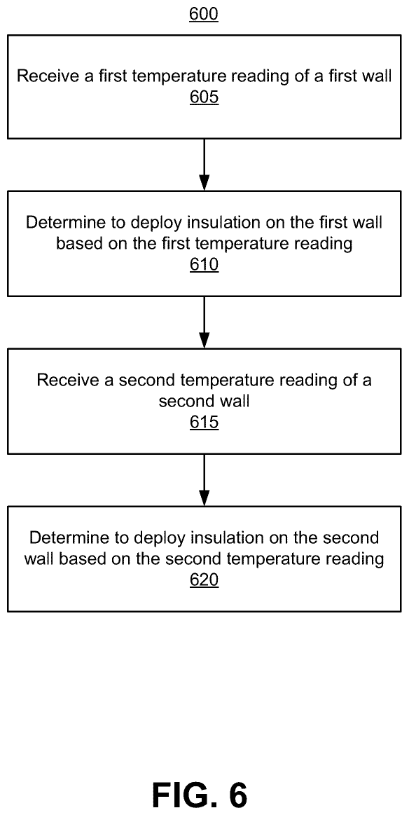

FIG. 6 is a flowchart of a process 600 for providing insulation for a building structure 100 according to an embodiment. In step 605, the computing device receives a first temperature reading of a first wall of the building structure 100 from a first set of sensors. The computing device can determine the first temperature reading based on an average of the temperature readings from each sensor of the first set of sensors.

In step 610, the computing device determines to deploy a first insulation component on the first wall based on the first temperature reading. For example, the computing device determines to deploy the first insulation component responsive to determining that the first temperature reading is less than (or greater than) a threshold temperature value. In this situation, the first temperature reading is a temperature of the ambient air outside the building structure 100, and the first temperature reading is based on output of sensors on the exterior side of the first wall. When the ambient air outside is cool, it is advantageous to deploy the insulation to retain heat that has been absorbed by the building structure 100.

In step 615, the computing device receives a second temperature reading of a second wall of the building structure 100 from a second set of sensors. The computing device can determine the second temperature reading based on an average of the temperature readings from each sensor of the second set of sensors.

In step 620, the computing device determines to deploy a second insulation component on the second wall based on the second temperature reading, independent of deployment of the first insulation component. For example, the computing device determines to deploy the second insulation component responsive to determining that the second temperature reading is less than (or greater than) a threshold temperature value. The threshold temperature value used to determine deployment of the first insulation component can be the same or different than the threshold temperature value used to determine deployment of second insulation component. In an embodiment, the threshold temperature values are different due to asymmetric properties of the first wall and second wall or other aspects of the building structure 100 resulting in greater or less insulation requirements for certain parts of the building structure 100. In another embodiment, the threshold temperature values are the same because the dimensions of the first wall and second wall are identical or substantially identical.

In some embodiments, the computing device determines to retract the insulation components responsive to determining that a temperature reading is greater than a threshold temperature value. For example, when the detected temperature inside the building structure 100 is too warm for produce being grown inside, the insulation should be retracted to allow the air to cool off inside the building structure 100.

In some embodiments, the computing device determines to deploy the first insulation component or second insulation component based on information other information as an alternative to, or in addition to, temperature readings of temperature sensors. For example, the deployment is based on the time of day. In another use case, the computing device determines to deploy insulation based on readings from a sensor that detects an amount of ambient outdoor light. In some embodiments, the computing device determines a predicted temperature reading of a wall (or another part of the building structure 100) at a future point in time (e.g., based on sensor data trends or historical temperature data), and determines to deploy insulation based at least in part on the predicted temperature reading.

In an embodiment, the sensors include one or more humidity sensors on the interior or exterior side (or both sides) of a wall. The computing device uses both humidity readings from the humidity sensors and temperature readings from the temperature sensors to control the insulation units. For example, the computing device determines to retract insulation responsive to determining that a temperature reading inside the building structure 100 is greater than a threshold temperature value and that a humidity reading inside the building structure 100 is greater than a threshold humidity value.

### III. Heating and Cooling

The building structure 100 includes one or more heating or cooling components. In the embodiment shown in FIGS. 1-5, the building structure 100 includes three water tanks 140. In other embodiments, the building structure 100 includes a different number of water tanks 140. The water tanks 140 are placed underground for insulation because the ground provides a natural thermal mass. The water tanks 140 are configured to store water for heating or cooling. For example, when the ambient outdoor temperature is cooler, a greater number of the water tanks 140 are configured to store warmer temperature water to provide heating for the building structure 100. In contrast, when the ambient outdoor temperature is warmer, a greater number of the water tanks 140 are configured to store cooler temperature water to provide cooling for the building structure 100. The water tanks 140 can be configured manually by a user or automatically by the computing device of the building structure 100. As previously described, the computing device automates control of the insulation deployment based on temperature readings from sensors. The computing device can also use the temperature readings from sensors to configure the water tanks 140.

In some embodiments, the computing device uses temperature readings to regulate the temperature of water inside a water tank 140. Since the bottom portion of a water tank 140 has a greater level of insulation in the ground, the upper portion of a water tank 140 experiences a greater degree of temperature fluctuation. In an example process, the computing device receives a temperature reading from a temperature sensor at a position on the bottom of the water tank 140. The computing devices receives a temperature reading from a temperature sensor at a position on the top of the water tank 140. The computing device determines a difference between the temperature readings at the bottom and top of the water tank 140. Responsive to determining that the difference is greater than a threshold temperature value, the computing device determines to operate a pump to mix water in the water tank 140. Mixing the water results in a more uniform temperature of the water inside the water tank 140.

In some embodiments, one or more of the water tanks 140 are used to supply water for the automatic watering system for indoor agriculture in the building structure 100.

In the embodiment shown in FIGS. 1-5, the building structure 100 includes a geothermal vent 150. The geothermal vent 150 helps maintain the temperature of air inside the building structure 100 by taking advantage of the thermal mass of the ground. A portion of the geothermal vent 150 is run through an underground trench 155. FIGS. 1-3 depict the trench 155 exposed for purposes of illustration; in practice, the trench 155 is filled up or covered during normal use of the building structure 100.

### IV. Power System

The building structure 100 includes a power system. In the embodiment shown in FIGS. 1-5, the building structure 100 includes a solar panel system 160. The solar panel system 160 captures and converts sunlight to electric energy. The solar panel system 160 includes components known to one skilled in the art. The solar panel system 160 stores converted energy into one or more batteries. The batteries are stored inside the building structure 100 or underground in the vicinity of the building structure 100. In various embodiments, the solar panel system 160 supplies all of the electric energy required to operate the building structure 100. For example, the solar panel system 160 supplies energy to the first insulation unit 130, second insulation unit 135, sensors 120, and pumps of the water tanks 140.

In combination with other previously described energy efficient solutions of the building structure 100, the solar panel system 160 enables the building structure 100 to be net-zero energy and independent of an electrical grid. The compact footprint of the building structure 100 reduces the energy consumption of the building structure 100. And due to the compact footprint and grid-independence of the building structure 100, the building structure 100 can be used in rural and residential settings, in addition to commercial agricultural settings such as farms.

### V. Additional Considerations

The foregoing description of the embodiments of the disclosure has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules can be embodied in software, firmware, hardware, or any combinations thereof.

Any of the steps, operations, or processes described herein can be performed or implemented with one or more hardware or software modules, alone or in combination with other devices. In some embodiments, a software module is implemented with a computer program product including a computer-readable non-transitory medium containing computer program code, which can be executed by a computer processor for performing any or all of the steps, operations, or processes described.

Embodiments can also relate to a product that is produced by a computing process described herein. Such a product can include information resulting from a computing process, where the information is stored on a non-transitory, tangible computer readable storage medium and can include any embodiment of a computer program product or other data combination described herein.

Finally, the language used in the specification has been principally selected for readability and instructional purposes, and it cannot have been selected to delineate or circumscribe the inventive subject matter. It is therefore intended that the scope of the invention be limited not by this detailed description, but rather by any claims that issue on an application based hereon. Accordingly, the disclosure of the embodiments herein is intended to be illustrative, but not limiting, of the scope of the invention, which is set forth in the following claims.

What is claimed is:

1. A building structure comprising:
a first wall comprising:
a first plurality of sensors configured to output a first temperature reading of the first wall, and
a first insulation unit configured to deploy a first insulation component on the first wall based on the first temperature reading; and
a second wall comprising:
a second plurality of sensors configured to output a second temperature reading of the second wall, and
a second insulation unit configured to deploy a second insulation component on the second wall based on the second temperature reading, independent of deployment of the first insulation component.

2. The building structure of claim 1, wherein the first insulation unit comprises:
a motor configured to deploy and retract the first insulation component on the first wall.

3. The building structure of claim 1, wherein the first insulation component comprises:
a roll of flexible insulation material, wherein the flexible insulation material is unrolled to cover a portion of the first wall when deployed.

4. The building structure of claim 1, wherein the first insulation component comprises:
a rigid panel of insulation material, wherein the rigid panel is rotated to cover a portion of the first wall when deployed.

5. The building structure of claim 1, wherein the first insulation unit can be re-positioned to deploy the first insulation component on another part of the building structure.

6. The building structure of claim 1, wherein the first wall further comprises:
a humidity sensor, wherein the first insulation unit is configured to deploy the first insulation component on the first wall based further on a humidity reading output by the humidity sensor.

7. The building structure of claim 1, further comprising:
a plurality of water tanks including a first water tank configured to store cold water and a second water tank configured to store warm water.

8. The building structure of claim 7, further comprising:
one or more pumps configured to mix water in the plurality of water tanks; and
a third plurality of sensors configured output temperature readings of the plurality of water tanks.

9. The building structure of claim 7, further comprising:
a solar panel system, wherein the first insulation unit, the second insulation unit, and the one or more pumps are powered in part by the solar panel system.

10. The building structure of claim 1, further comprising:
an automatic watering system for indoor agriculture.

11. The building structure of claim 1, wherein the first plurality of sensors includes a first array of sensors positioned on an interior of the building structure and a second array of sensors positioned on an exterior of the building.

12. A method for providing insulation for a building structure, the method comprising:
receiving, from a first plurality of sensors of a first wall of the building structure, a first temperature reading of the first wall;
determining to deploy a first insulation component on the first wall based on the first temperature reading;
receiving, from a second plurality of sensors of a second wall of the building structure, a second temperature reading of the second wall; and
determining to deploy a second insulation component on the second wall based on the second temperature reading, independent of deployment of the first insulation component.

13. The method of claim 12, further comprising:
determining a predicted temperature reading of the first wall at a future point in time, wherein determining to deploy the first insulation component on the first wall is based further on the predicted temperature reading.

14. The method of claim 12, further comprising:
receiving a third temperature reading at a position of a water tank of the building structure;
receiving a fourth temperature reading at a different position of the water tank;
determining a difference between the third temperature reading and the fourth temperature reading; and
responsive to determining that the difference is greater than a threshold temperature value, operating a pump to mix water in the water tank.

15. The method of claim 12, further comprising:
receiving a humidity reading from a humidity sensor inside the building structure;
receiving an interior temperature reading of building structure; and
determining to retract the first insulation component on the first wall responsive to:
determining that the humidity reading is greater than a threshold humidity value, and
determining that the interior temperature reading is greater than a threshold temperature value.
